(19) United States
(12) Patent Application Publication
(10) Pub. No.: US 2026/0343521 A1
(43) Pub. Date: Oct. 29, 2026

(54) CHANNEL AWARE CONFIGURATION OF SEMI-PERSISTENT SCHEDULING

(71) Applicant: QUALCOMM Incorporated, San Diego, CA (US)

(72) Inventors: Amit BAR-OR TILLINGER, Tel Aviv (IL); Shay LANDIS, Hod Hasharon (IL); Ran BERLINER, Kfar Aviv (IL); Konstantin KUPERSHLAK, Ramat Gan (IL)

(21) Appl. No.: 19/193,383

(22) Filed: Apr. 29, 2025

(51) Int. Cl. H04W 72/11; H04L 5/00

(52) U.S. Cl. CPC H04W 72/11; H04L 5/006; H04L 5/0098

(57) ABSTRACT

Some aspects of the present disclosure provide techniques for wireless communications. An example method includes receiving a semi-persistent scheduling (SPS) configuration that indicates a trigger condition for modifying an SPS parameter, wherein the SPS parameter is indicated by activation signaling for an SPS resource of the SPS configuration; receiving the activation signaling indicating the SPS parameter; and communicating, based on a channel condition satisfying the trigger condition, using a modified SPS parameter, the modified SPS parameter being based on modifying the SPS parameter.

### INTRODUCTION

### Field of the Disclosure

Aspects of the present disclosure relate to wireless communications, and more particularly, to techniques for channel aware configuration of semi-persistent scheduling (SPS).

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Semi-persistent scheduling (SPS) is a scheme employed to ensure proper allocation of transmission resources for services that connect and transmit periodically, such as Voice over IP (VoIP) or Vehicle to Everything (V2X) applications. SPS reduces control signaling overhead by allocating resources on a semi-persistent basis, thus retaining an transmission resource allocation over a defined time interval. Due to the volatile nature of the transmission channel, especially in situations where a user equipment (UE) is traveling at high velocity, the efficiency gained by using SPS may erode as channel conditions change and SPS cannot adapt.

Aspects described herein provide various schemes for allowing the SPS parameters, and thus the resources allocated through SPS, to be updated dynamically as channel conditions change to enhance scheduling performance. The techniques for channel aware SPS described herein may enable improved wireless communication performance, such as reduced latencies and packet losses, increased spectral efficiency and/or network capacity, and minimized control signaling overhead.

One aspect provides a method for wireless communications by a user equipment (UE). The method includes receiving a semi-persistent scheduling (SPS) configuration that indicates a trigger condition for modifying an SPS parameter, wherein the SPS parameter is indicated by activation signaling for an SPS resource of the SPS configuration; receiving the activation signaling indicating the SPS parameter; and communicating, based on a channel condition satisfying the trigger condition, using a modified SPS parameter, the modified SPS parameter being based on modifying the SPS parameter.

Another aspect provides a method for wireless communications by a network entity. The method includes transmitting a SPS configuration that indicates a trigger condition for modifying an SPS parameter, wherein the SPS parameter is indicated by activation signaling for an SPS resource of the SPS configuration; transmitting the activation signaling indicating the SPS parameter; and communicating, based on a channel condition satisfying the trigger condition, using a modified SPS parameter, the modified SPS parameter being based on modifying the SPS parameter.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts a process flow for closed-loop feedback associated with a communication channel between a network entity and a UE.

FIG. 6 depicts a process flow for channel aware semi-persistent scheduling (SPS) configuration communications in a network.

FIG. 7 depicts a method for wireless communications.

FIG. 8 depicts another method for wireless communications.

FIG. 9 depicts aspects of an example communications device.

FIG. 10 depicts aspects of an example communications device.

### DETAILED DESCRIPTION

Aspects of the present disclosure provide apparatuses, methods, processing systems, and computer-readable mediums for channel aware configuration of semi-persistent scheduling (SPS).

Wireless communication networks are expected to deliver high quality-of-service (QoS) for a variety of use cases, such as ultra-reliable Low-Latency Communication (uRLLC), Massive Machine-Type Communication (mMTC), and Enhanced Mobile Broadband (eMBB). As a result, scheduling of data transmissions is a foundational aspect of mobile networks, with the performance of a network's data throughput depending on scheduling algorithms.

A scheduling algorithm dynamically allocates resources, including time, frequency, and power, to serve user equipment (UEs) connected to a network entity (such as a gNB) on a network such as a 5G network. The data scheduler exists in the network entity and coordinates the data transmissions on both uplink and downlink legs for all UEs within its cell range. A scheduling algorithm may use three primary sets of information. First is the QoS expectations, e.g., the priorities, maximum error rates or maximum delays of the individual UE or a communication. Second is the data buffer status for each UE, e.g., the amount of data in the transfer buffers and the length of time that the data has been in the buffers. For example, there may be delay-sensitive data which will have higher priority than some bulk download data. Third are channel conditions. For instance, a UE may have lots of data in its transmission buffer, but the UE may be subject to weak channel conditions such that no matter the amount of radio resources allocated for the UE, not much data will get through. These considerations may guide the amount of resources, particular resources, or configuration of resources (such as modulation and coding scheme) scheduled or allocated for the UE.

In some scheduling algorithms, an individual UE sends a scheduling request (SR) in a physical uplink control channel (PUCCH) to a network entity when the UE expects to transmit data to the network entity or has data to transmit to the network entity. The network entity can dynamically allocate uplink transmission resources based on the SR. The network entity sends a grant to the UE using downlink control information (DCI) in a physical downlink control channel (PDCCH). The grant allows the UE to transmit data according to the allocated resources in a physical uplink shared channel (PUSCH). For services involving regular intervals of data transmission, such as Voice over IP (VoIP) or Vehicle to Everything (V2X), a semi-persistent scheduling (SPS) algorithm may be particularly useful.

In SPS, a network entity configures recurring time and frequency resources for a UE for a period of time, thus reducing the need for constant scheduling updates. Also, by allowing UEs to transmit data periodically without requesting new scheduling information every time (and by eliminating the transmission of scheduling information before each recurring resource), latency and control signaling overhead are reduced. SPS includes SPS parameters that define specific resources, the resource periodicity (e.g., the interval at which resources are allocated), and the resource retention (e.g., the length of time that resources are retained). Thus, each UE is granted a “semi-persistent” transmission window. However, a technical problem with the “semi-persistent” nature of SPS is that SPS may not adapt to changing channel conditions. This reduces the efficiency of SPS over time as the channel conditions change. This may be particularly impactful in situations where UEs may be traveling at high velocity because of the potential for large variances in the channel conditions in a shorter period of time. In some scheduling algorithms, the UE may receive a resource allocation from the network through control signaling, e.g., radio resource control (RRC), during connection setup or configuration. Further, SPS uses DCI to update the UE about the resource allocation using a configured scheduling radio network temporary identifier (CS-RNTI) as an activation signal.

Time division duplexing (TDD) has become common in higher frequency bands such as FR2 and FR3, where full duplex is more attractive and amenable to implementation of wireless communications. In such environments, channel reciprocity may be assumed, where conditions that may be detected and reported in one direction (such as the uplink from the UE to the network or the downlink from the network to the UE) are assumed to exist in both directions.

Aspects described herein relate to techniques for channel-aware configuration of SPS. Such techniques allow the SPS parameters to be dynamically changed such as based on channel conditions at the UE. In some aspects, channel-aware SPS parameters may be introduced by transmitting a configuration, such as an SPS configuration, that indicates a trigger condition for updating SPS parameters at the UE based on channel conditions. In some examples, the configuration also may provide a range of possible values for the SPS parameters at the UE, such as a range of potential resource allocations or a range of potential modulation and coding schemes.

In some examples, activation signaling may be based on information within or indicated by the CS-RNTI. For instance, the bits used to define a frequency domain resource assignment field in the DCI may be used to indicate, or specify, a range of resource blocks for an SPS configuration using any of a variety of techniques. For instance, one or more resource blocks that are associated with a maximal capacity or signal-to-noise ratio, as indicated by the current channel conditions, may be selected and included in the range of resource blocks. Another technique may include selecting and including a group of contiguous resource blocks that lead to the maximal capacity or signal-to-noise ratio. Yet another technique may be to select and include any resource block that satisfies a defined threshold for capacity or signal-to-noise ratio.

Some other aspects may select and exclude resource blocks with a low capacity or signal-to-noise ratio. In such aspects, resource blocks may be selected that lead to a capacity or signal-to-noise ratio below a defined threshold, and these resource blocks may be excluded from the range of resource blocks. Similarly, a group of (e.g., contiguous) resource blocks with a lowest capacity or signal-to-noise ratio may be excluded from the range indicated in the DCI. In some other aspects, an MCS and rank, indicated in the configuration or the DCI, may be modified in the CS-RNTI information within the DCI as indicated by the measured channel conditions. Such modified DCI may be known as channel-aware CS-RNTI, or CACS-RNTI.

The CACS-RNTI may be used as activation signaling for the channel aware SPS, where the activation signaling also provides an initial value for SPS parameters to be updated in the course of the communication. From that point, the UE and network entity may estimate the channel conditions (e.g., regularly). If the trigger condition indicated in the initial configuration is satisfied, the UE and network entity may update SPS parameters in accordance with the measured channel conditions.

The techniques described herein may have the technical benefits of enhancing overall SPS performance, improving spectral efficiency, and increasing network capacity.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

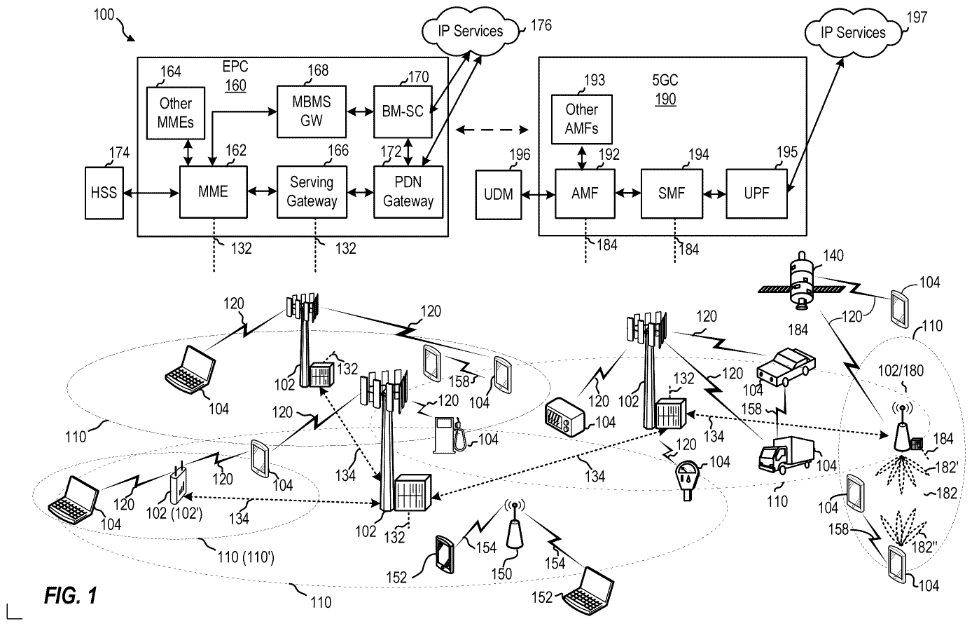

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

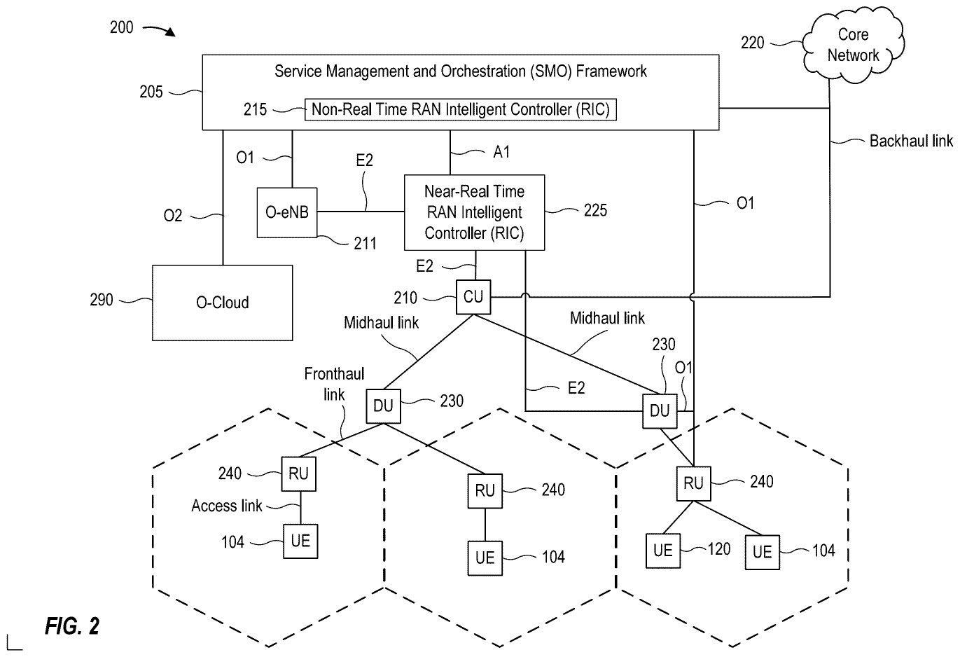

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR 1) as including 410 MHz-7125 MHz, which is often referred to (interchangeably) as “Sub-6 GHz”. Similarly, 3GPP currently defines Frequency Range 2 (FR 2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QOS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

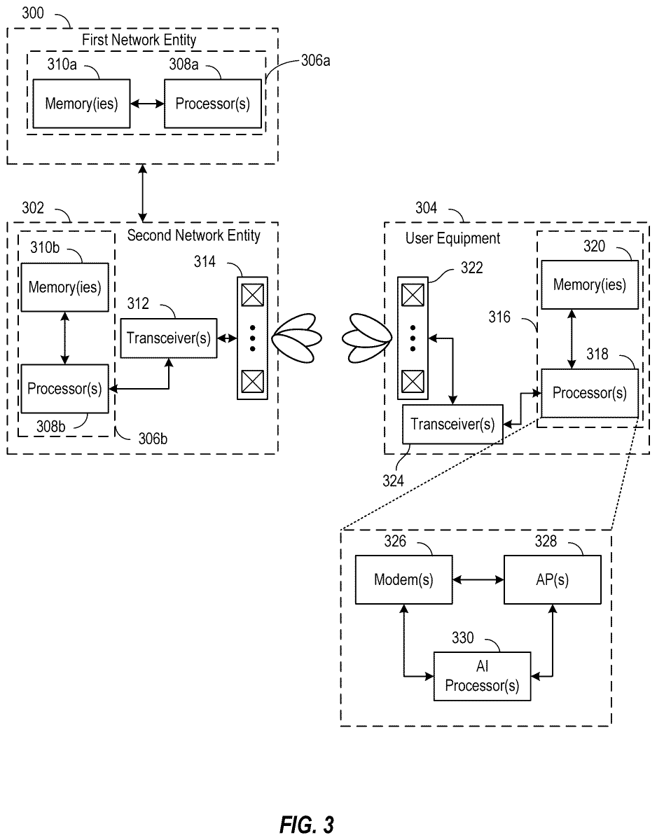

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

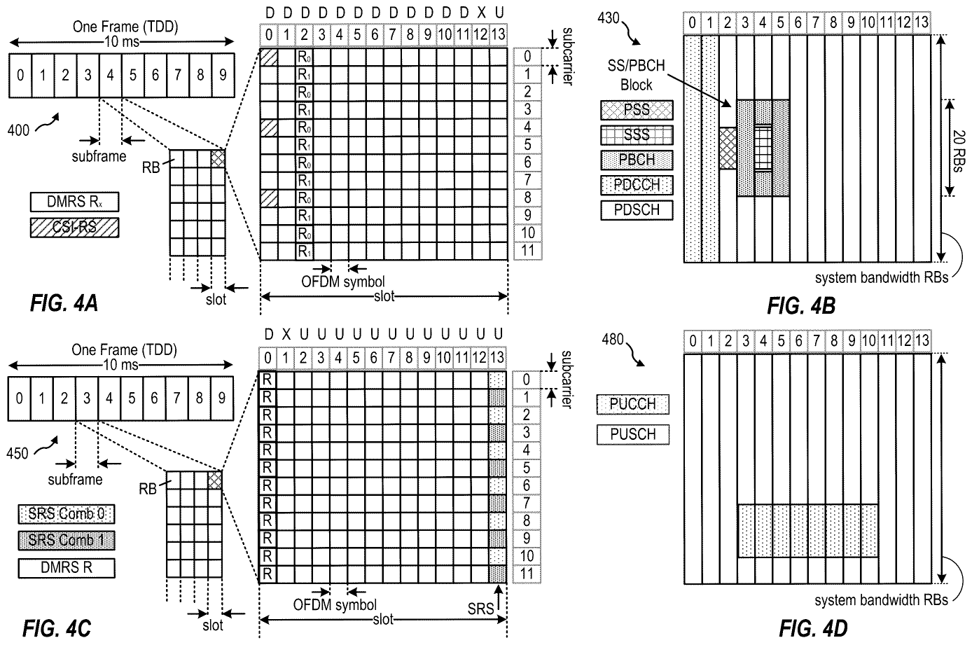

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In some aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In some aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Channel State Feedback

In certain wireless communication systems, closed-loop feedback associated with a communication channel between a UE and a network entity may be used to dynamically adapt communication parameters to channel conditions that may change over time. In certain cases, a UE may transmit a reference signal (e.g., DMRS, SRS, etc.), and a network entity (or another UE) may determine characteristics associated with the channel based on measurements of the received reference signal. In some cases, a UE may receive a reference signal (e.g., SSB, CSI-RS, DMRS, PT-RS, etc.) from a network entity (or another UE) and report channel state feedback to the network entity (or the other UE), where the channel state feedback is determined based on measurements of the reference signal received at the UE.

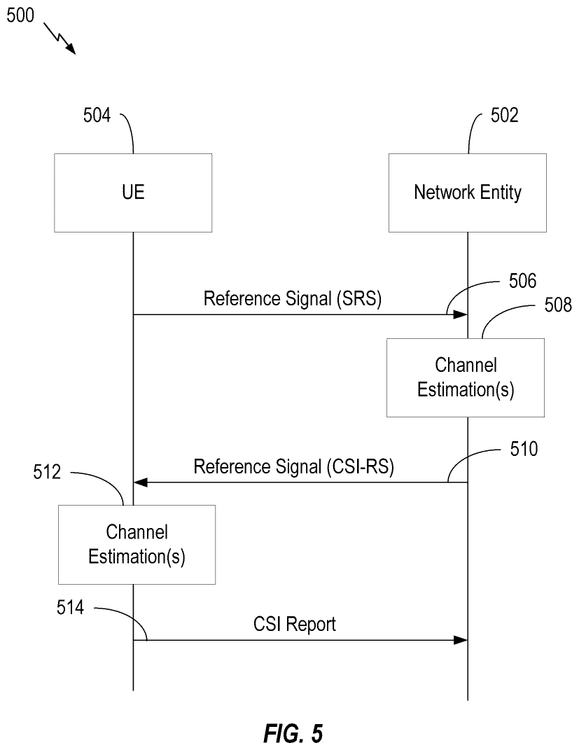

FIG. 5 depicts a process flow 500 for closed-loop feedback associated with a communication channel between a network entity 502 and a UE 504.

At 506, UE 504 sends a reference signal (e.g., SSB, CSI-RS, DMRS, PT-RS, SRS, etc.) to the network entity 502. In some aspects, the UE 504 may send the reference signal (e.g., SRS) using one or more receive antenna ports, which may correspond to an SRS port or SRS antenna port. Transmission of the SRS via the receive antenna port may enable the network entity 502 to deduce the downlink propagation channel associated with the receive antenna port based on channel reciprocity.

At 508, the network entity 502 performs channel calculations based on the reference signal, such as determining a channel estimate H based on the received reference signal, for example, as further described herein with respect to the UE performing channel calculations at 512. In some aspects, the network entity 502 may further calculate, as part of the channel calculations, a precoder (e.g., precoder matrix) V based on the channel estimate H, for example, as further described herein with respect to the UE 504 performing such a calculation. Accordingly, the network entity 502 may determine H and/or V for an uplink channel between UE 504 and network entity 502 based on SRS. Further, the uplink channel between UE 504 and network entity 502 may have reciprocity with a downlink channel between UE 504 and network entity 502. Accordingly, the determined values of H and/or V for the uplink channel between UE 504 and network entity 502 may be used for the downlink channel between UE 504 and network entity 502. In some cases, the reciprocity between the uplink channel and the downlink channel may be based on a known difference between the uplink channel and the downlink channel, such that the difference can be represented by a function. Accordingly, in some aspects, to determine H and/or V for the downlink channel, the network entity 502 may apply a function to H and/or V determined for the uplink channel.

At 510, the UE 504 receives a reference signal (e.g., SSB, CSI-RS, etc.) from the network entity 502. In some aspects, the network entity may send the reference signal with precoding (e.g., beamforming, MIMO layer(s), and/or compensation for signal propagation effects) based on the channel estimate and/or precoder determined at 508.

At 512, the UE 504 performs channel calculations based on the reference signal, such as determining a channel estimate H based on the received reference signal. For example, the UE 504 may include a demodulator or a baseband processor, which may be part of a modem (e.g., the modem(s) 326) of UE 504. The demodulator, such as a component of the modem, may obtain as input the reference signal as received over multiple antennas of the UE 504 and output (or determine) a vector \vec{y} that is a representation of the received reference signal as received over each of the multiple antennas of the UE 504.

Based on a received signal model, the vector y can be represented as follows in equation (1):

\vec{y}=H\vec{x}+\vec{n} (1)

In equation (1), H corresponds to a matrix representation of the communications channel, as in a channel estimate of the communications channel the signal is communicated in (e.g., downlink communication channel where the reference signal is communicated), \vec{x} is the vector representing symbols transmitted by network entity 502 over a number of spatial layers, and \vec{n} is noise across the communications channel. In some aspects, H has a size equal to the number of antennas used to receive the signaling, Nₐₙₜ, times the number of spatial layers, Nₗ, (e.g., the number of beamformed transmissions, number of antenna ports, etc.). For example, H has a number of rows equal to Nₐₙₜ and a number of columns equal to Nₗ. In some aspects, the symbols that form the reference signal are known by the UE 504 (e.g., configured or preconfigured at the UE). UE 504 can determine the channel estimate H based on receiving the reference signal.

In some aspects, UE 504 may further calculate, as part of the channel calculations, a precoder (e.g., precoder matrix) V based on the channel estimate H. For example, UE 504 may be configured to perform singular value decomposition (SVD) based precoding to determine the precoder V. For example, SVD(H)=[U S V], such that SVD provides the precoder V. U may be related to the ordering of the rows of H, as in the ordering of the antennas as represented by H. It should be understood that other suitable techniques may be used to determine the precoder V based on the channel estimate H.

At 514, UE 504 sends to the network entity 502 a CSI report indicating the determined channel estimate H and/or precoder V. For example, the UE may determine one or more CSI parameters, such as channel quality indicator (CQI), precoding matrix indicator (PMI), and/or rank indicator (RI) based on H and/or V. RI may represent the number of MIMO layers requested by the UE for downlink transmissions. PMI may define a set of indices corresponding to one or more precoding matrices (e.g., the precoding matrix V) to apply to downlink transmissions. In some aspects, the PMI may indicate the UE's preferred precoding for downlink transmissions on the PDSCH. CQI may be an indicator of the UE's preferred modulation and coding scheme for downlink transmissions. The UE 504 may send an indication of the one or more determined CSI parameters to the network entity 502 in the CSI report. The network entity 502 may schedule downlink data transmissions to the UE 504 accordingly, such as using a modulation scheme, code rate, number of MIMO layers, or the like, that the network entity determines based on the CSI report.

### Example Artificial Intelligence for Wireless Communications

Some aspects described herein may be implemented, at least in part, using some form of artificial intelligence (AI), e.g., the process of using a machine learning (ML) model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

ML is often characterized in terms of types of learning that generate specific types of learned models that perform specific types of tasks. For example, different types of machine learning include supervised learning, unsupervised learning, semi-supervised learning, and reinforcement learning.

Supervised learning algorithms generally model relationships and dependencies between input features (e.g., a feature vector) and one or more target outputs. Supervised learning uses labeled training data, which are data including one or more inputs and a desired output. Supervised learning may be used to train models to perform tasks like classification, where the goal is to predict discrete values, or regression, where the goal is to predict continuous values. Some example supervised learning algorithms include nearest neighbor, naive Bayes, decision trees, linear regression, support vector machines (SVMs), and artificial neural networks (ANNs).

Unsupervised learning algorithms work on unlabeled input data and train models that take an input and transform it into an output to solve a practical problem. Examples of unsupervised learning tasks are clustering, where the output of the model may be a cluster identification, dimensionality reduction, where the output of the model is an output feature vector that has fewer features than the input feature vector, and outlier detection, where the output of the model is a value indicating how the input is different from a typical example in the dataset. An example unsupervised learning algorithm is k-Means.

Semi-supervised learning algorithms work on datasets containing both labeled and unlabeled examples, where often the quantity of unlabeled examples is much higher than the number of labeled examples. However, the goal of a semi-supervised learning is that of supervised learning. Often, a semi-supervised model includes a model trained to produce pseudo-labels for unlabeled data that is then combined with the labeled data to train a second classifier that leverages the higher quantity of overall training data to improve task performance.

Reinforcement learning algorithms use observations gathered by an agent from an interaction with an environment to take actions that may maximize a reward or minimize a risk. Reinforcement learning is a continuous and iterative process in which the agent learns from its experiences with the environment until it explores, for example, a full range of possible states. An example type of reinforcement learning algorithm is an adversarial network. Reinforcement learning may be particularly beneficial when used to improve or attempt to optimize a behavior of a model deployed in a dynamically changing environment, such as a wireless communication network.

ML models may be deployed in one or more devices, e.g., network entities, UEs, and remote servers, to support various wired and/or wireless communication aspects of a communication system. For example, an ML model may be trained to identify patterns and relationships in data corresponding to a network, a device, an air interface, or the like. An ML model may improve operations relating to one or more aspects, such as transceiver circuitry controls, frequency synchronization, timing synchronization, channel state estimation, channel equalization, channel state feedback, modulation, demodulation, device positioning, transceiver tuning, beamforming, signal coding/decoding, network routing, load balancing, and energy conservation (to name just a few) associated with communications devices, services, and/or networks. AI-enhanced transceiver circuitry controls may include, for example, filter tuning, transmit power controls, gain controls (including automatic gain controls), phase controls, power management, and the like. For example, an ML model may be used to configure SPS parameters based on measured channel conditions.

Aspects described herein may describe the performance of certain tasks and the technical solution of various technical problems by application of a specific type of ML model, such as an ANN. It should be understood, however, that other type(s) of AI models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such “AI model,” “ML model,” “AI/ML model,” “trained ML model,” and the like are intended to be interchangeable.

In some aspects, a model server may perform any of various ML model lifecycle management (LCM) tasks for wireless devices. The model server may update the ML model(s) using training data. In some cases, the model server may operate as a data source to collect and host training data, inference data, and/or performance feedback associated with an ML model. In some aspects, the model server may host various types and/or versions of the ML model(s) for wireless devices to download.

In some cases, the model server may monitor and evaluate the performance of the ML model to trigger one or more LCM tasks. For example, the model server may determine whether to activate or deactivate the use of a particular ML model at a wireless device, and the model server may provide such an instruction to the respective wireless device. In some cases, the model server may determine whether to switch to a different ML model being used at the wireless device, and the model server may provide such an instruction to the respective wireless device. In some examples, the model server may also act as a central server for decentralized machine learning tasks, such as federated learning.

### Example Signaling of Channel Aware SPS Configuration

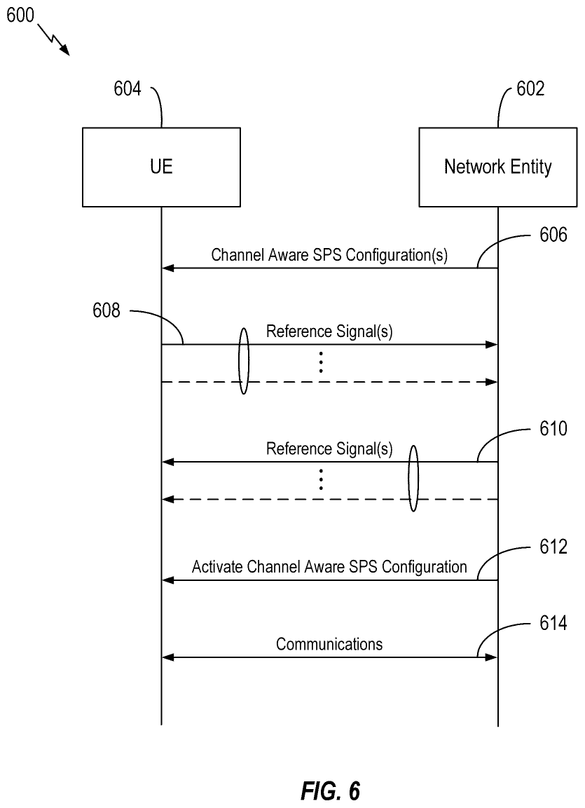

FIG. 6 depicts a process flow 600 for communications in a system between a network entity 602 and a UE 604. In some aspects, the network entity 602 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 604 may be an example of UE 104 depicted and described with respect to FIG. 1 or the UE 304 depicted and described with respect to FIG. 3. In certain cases, the UE 604 may be an example of the UE 504 of FIG. 5. However, in other aspects, UE 604 may be another type of wireless communications device, and network entity 602 may be another type of network entity or network node, such as those described herein. Note that any operations or signaling illustrated with dashed lines may indicate that that operation or signaling is an optional or alternative example.

At 606, an SPS configuration is sent to the UE 604 from the network entity 602. The SPS configuration may include an initial set of SPS parameters. For example, the initial set of SPS parameters may indicate resources that may be used in DCI, which may be scrambled with an RNTI referred to as a channel aware CS-RNTI (CACS-RNTI). In some aspects, the DCI is specific to indication of channel-aware parameters for SPS (e.g., the DCI may be an alternative to DCI scrambled with CS-RNTI). The DCI (for example, DCI format 1_0) may include fields such as DCI Format Indicator, which identifies the format of the DCI, Frequency Domain Resource Assignment, which specifies the allocated resource blocks (RBs) in the frequency domain, Time Domain Resource Assignment, which indicates the time domain resources, VRB-to-PRB Mapping, which specifies the mapping from virtual resource blocks (VRBs) to physical resource blocks (PRBs), Modulation and Coding Scheme (MCS), which determines the modulation and coding scheme for data transmission, New Data Indicator (NDI), which indicates whether the data is new or a retransmission, Redundancy Version (RV), which specifies the redundancy version for Hybrid Automatic Repeat Request (HARQ), HARQ Process Number, which identifies the HARQ process, Downlink Assignment Index (DAI), which is used for multi-slot scheduling, TPC Command for PUCCH, or the Transmit Power Control command for the Physical Uplink Control Channel (PUCCH), and PDSCH-to-HARQ Feedback Timing Indicator, which indicates the timing for HARQ feedback. At least a subset of these fields may include SPS parameters, such as frequency domain resource assignment, time domain resource assignment, MCS, rank, or the like.

In some aspects, the initial configuration includes a trigger condition for modifying certain SPS parameters once the activation signal described below has been completed. The initial channel aware configuration may be sent using RRC signaling, fields in the DCI formats, or a combination of the two. For instance, specific channel condition measurements, e.g., signal power or signal-to-noise ratio (SNR), may be defined in a reference table and an RRC message may be sent to indicate a threshold for a trigger condition. In this example, if a field indicates an SNR and the RRC message indicates a threshold of 6 dB, the channel aware SPS configuration indicates that modifications to the SPS parameters based on the channel aware mechanism are not triggered until a 6 dB change in SNR is detected.

At 608, the UE 604 sends one or more reference signals, e.g., the SRS or the DMRS transmitted by the UE 504 of FIG. 5, such that the network entity 602 may measure the channel conditions, e.g., SNR or capacity, and use the channel conditions to modify SPS parameters according to the initial configuration and depending on the trigger condition being satisfied. The network entity 602 may measure the one or more reference signals.

At 610, the network entity 602 sends one or more reference signals, e.g., the CSI-RS, SSB, LP-SS, DMRS, or TRS transmitted by the network entity 502 of FIG. 5, such that the UE 604 may measure the channel conditions. The UE 604 may measure the one or more reference signals. In some aspects, the UE 604 may report a measurement to the network entity 602, or the network entity 602 may report a measurement to the UE 604.

At 612, network entity 602 transmits the activation signaling for the channel aware SPS. The activation signaling may indicate initial values for one or more of the SPS parameters. In some aspects, the activation signaling may be DCI scrambled with a channel aware (CA) CS-RNTI DCI (e.g., DCI scrambled with a CACS-RNTI). As mentioned above, some SPS signaling uses CS-RNTI DCI as an activation signal, along with a specified DCI format with related SPS parameters. These parameters do not typically change while an SPS session is ongoing. So, while the channel information at the network entity may be updated upon CS-RNTI DCI activation, as time progresses, the channel may vary and the SPS parameters within the DCI might become stale.

In some aspects, the DCI format may be arranged such that the field representing the Frequency Domain Resource Assignment parameter in the DCI may define a resource block (RB) range which defines all candidate RBs for SPS communication. In such a case, the field can keep the same number of bits to simplify implementation. In some examples, the field representing the Frequency Domain Resource Assignment parameter may include an RB number which defines a number of RBs to select from an RB range based on measured channel conditions. For instance, the number may be used to select a number of RBs that lead to the highest SNR value or capacity value or may represent number of RBS in a set of continuous RBs that achieve maximal SNR values or capacity values.

In some aspects, RBs with an SNR value or a capacity value satisfying a threshold may be selected from the range for transmission, which would represent a dynamic number of RBs. Additionally, or alternatively, RBs in the range that have an SNR value or a capacity value below a defined threshold may be excluded from being transmitted. Additionally, or alternatively, a number of RBs in the range of RBs that have a lowest SNR value or capacity value may be excluded from being transmitted.

In other aspects, one or more fields in the CS-RNTI DCI, e.g., MCS or rank, may be modified dynamically using the channel aware configuration. For instance, the Modulation and Coding Scheme field may be modified in addition to or as an alternative to including or excluding RBs from a range or selecting a number of RBs. As an example, a set of rules may be defined such that as measured channel conditions change, the MCS of the transmission can be modified. This scheme may have the technical benefit of increasing or decreasing the MCS without additional overhead in the PDCCH.

In some aspects, the set of rules that are defined for modification of SPS parameters may be based on an AI/ML machine, as described above, that is used both by the UE 604 and the network entity 602. The AI/ML machine generates updated values for the SPS parameters based on an input of the measured channel conditions.

At 614, the network entity 602 and UE 604 may communicate using the resources that are available and according to the current configuration. For example, the network entity 602 may transmit, and the UE 604 may receive, a communication on an SPS resource according to a dynamically updated SPS parameter. As another example, the network entity 602 may receive, and the UE 604 may transmit, a communication on an SPS resource according to a dynamically updated SPS parameter. The dynamically updated SPS parameter may include a time-domain resource allocation, a frequency-domain resource allocation, an MCS, a rank, a transmit power control parameter, or the like.

Both network entity 602 and UE 604 continue to measure the channel conditions and may update the SPS parameters based on measured channel conditions and subject to the trigger condition being satisfied, as described above. As a result, steps 608 and 610 may be repeated by network entity 602 and UE 604 to keep the measurement of channel conditions up to date.

In some aspects, the measurement of channel conditions may be further configured to reduce occurrence of mismatched channel information between the network entity 602 and UE 604. For example, UE 604 may keep the default values for MCS parameters as configured by the initial DCI, unless a change in SPS parameter improves a criterion by more than a threshold (configured by network entity 602). For instance, updates to the SPS parameters may only be triggered when the new channel aware SPS configuration provides an improvement above the threshold. As another example, the UE 604 and the network entity 602 use delayed information to update SPS parameters at either or both of the network entity 602 and UE 604. For instance, measurements to be used to update the SPS parameters may be the last reported measurements (in either direction). Additionally, or alternatively, the UE 604 and/or the network entity 602 may be configured to use measurements that are older than a threshold (e.g., a specific delayed number of slots or time).

Note that the process flow illustrated in FIG. 6 is described herein to facilitate an understanding of channel aware SPS configuration, and aspects of the present disclosure may be performed in various manners via alternative or additional signaling and/or operations. In some aspects, the operations and/or signaling of FIG. 6 may occur in an order different from that described or depicted, and various actions, operations, and/or signaling may be added, omitted, or combined.

### Example Operations of a User Equipment

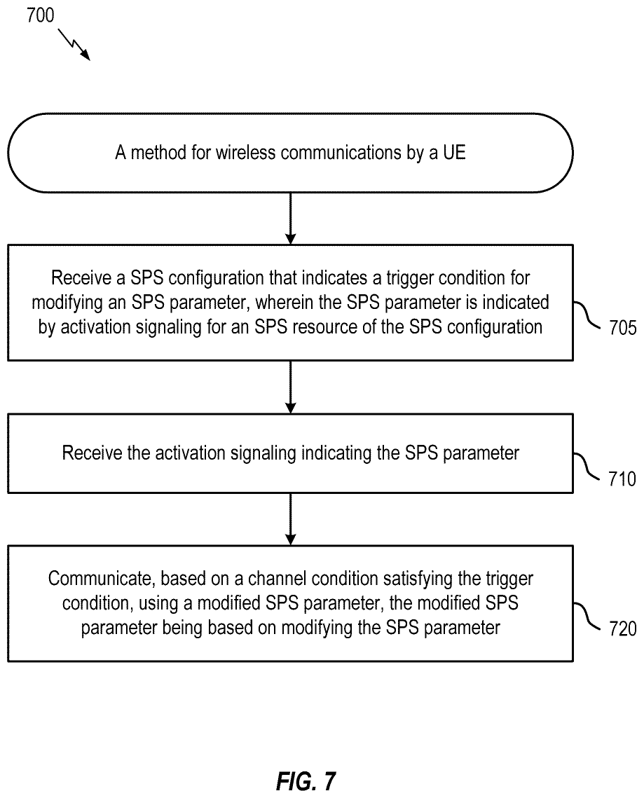

FIG. 7 shows a method 700 for wireless communications by a UE, such as UE 104 of FIG. 1 or UE 304 of FIG. 3.

Method 700 begins at block 705 with receiving a SPS configuration that indicates a trigger condition for modifying an SPS parameter, wherein the SPS parameter is indicated by activation signaling for an SPS resource of the SPS configuration.

Method 700 then proceeds to block 710 with receiving the activation signaling indicating the SPS parameter.

Method 700 then proceeds to block 720 with communicating, based on a channel condition satisfying the trigger condition, using a modified SPS parameter, the modified SPS parameter being based on modifying the SPS parameter.

In some aspects, method 700 further includes measuring the channel condition.

In some aspects, method 700 further includes modifying the SPS parameter, to obtain the modified SPS parameter, based on the trigger condition and the channel condition.

In some aspects, method 700 further includes modifying the SPS parameter without receiving signaling indicating to modify the SPS parameter.

In some aspects, modifying the SPS parameter comprises modifying the SPS parameter, based on the channel condition, using a machine learning model.

In some aspects, the SPS parameter indicates a range of resource blocks for transmission, wherein block 720 includes communicating on one or more resource blocks of the range of resource blocks.

In some aspects, the channel condition is based on a SNR or a capacity, and wherein the one or more resource blocks are based on one or more SNR values or one or more capacity values of the one or more resource blocks.

In some aspects, the SPS parameter further indicates a number of selected resource blocks, wherein the one or more resource blocks include the number of selected resource blocks.

In some aspects, another resource block, of the range of resource blocks, is excluded from the one or more resource blocks based on an associated SNR value or an associated capacity value of the other resource block failing to satisfy a second threshold.

In some aspects, method 700 further includes determining that the trigger condition is no longer satisfied.

In some aspects, method 700 further includes communicating using a default SPS parameter in accordance with the trigger condition not being satisfied.

In some aspects, the trigger condition comprises a change in a SNR value or a capacity value of the channel condition satisfying a threshold.

In some aspects, the channel condition is based on a past measurement according to a time delay.

In some aspects, the SPS parameter includes a first modulation and coding scheme and the modified SPS parameter includes a second modulation and coding scheme.

In some aspects, the SPS parameter includes a first rank and the modified SPS parameter includes a second rank.

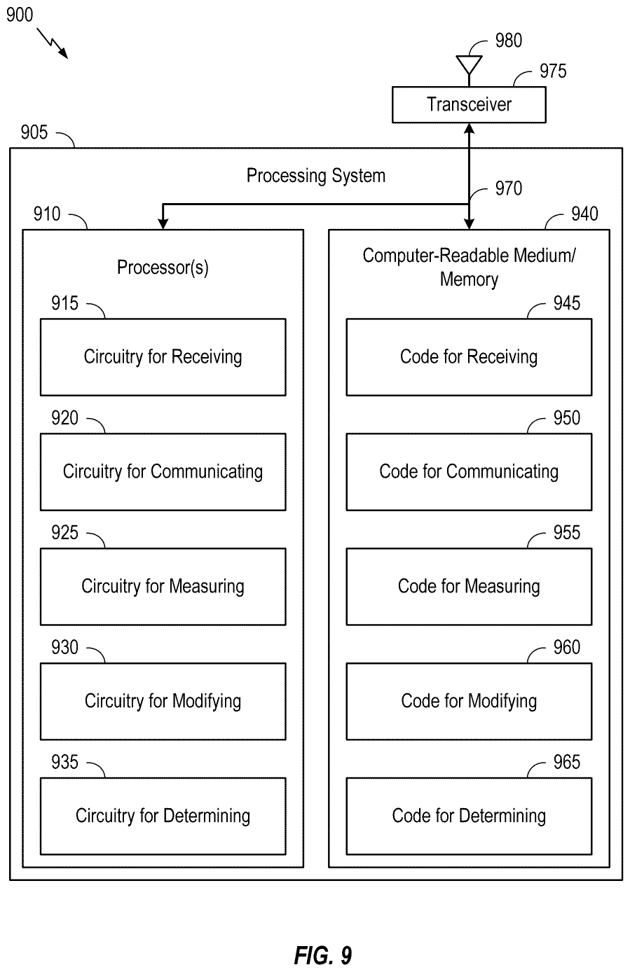

In some aspects, method 700, or any aspect related to it, may be performed by an apparatus, such as communications device 900 of FIG. 9, which includes various components operable, configured, or adapted to perform the method 700. Communications device 900 is described below in further detail.

Note that FIG. 7 is just one example of a method, and other methods including fewer, additional, or alternative operations are possible consistent with this disclosure.

### Example Operations of a Network Entity

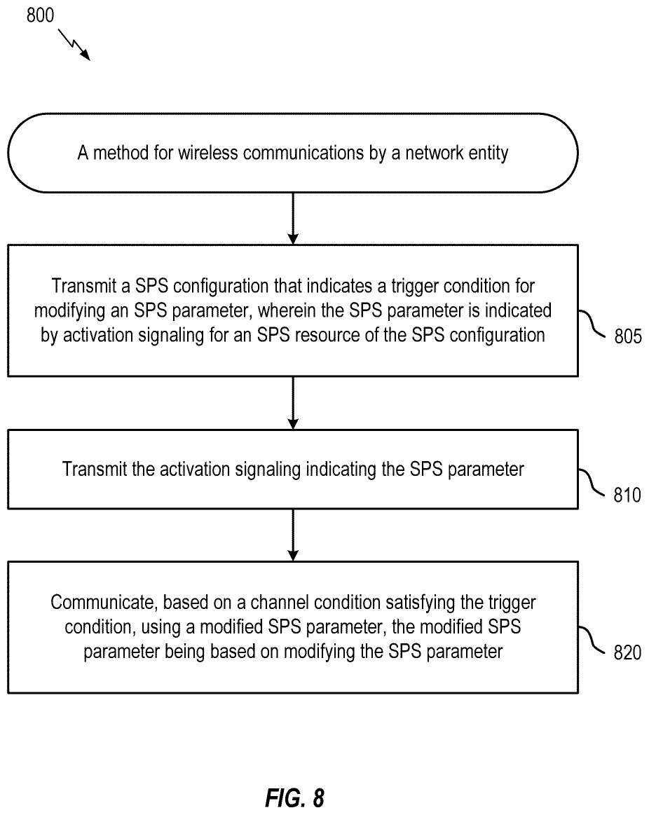

FIG. 8 shows a method 800 for wireless communications by a network entity, such as BS 102 of FIG. 1, a first network entity 300 or second network entity 302 of FIG. 3, or a disaggregated base station as discussed with respect to FIG. 2.

Method 800 begins at block 805 with transmitting a SPS configuration that indicates a trigger condition for modifying an SPS parameter, wherein the SPS parameter is indicated by activation signaling for an SPS resource of the SPS configuration.

Method 800 then proceeds to block 810 with transmitting the activation signaling indicating the SPS parameter.

Method 800 then proceeds to block 820 with communicating, based on a channel condition satisfying the trigger condition, using a modified SPS parameter, the modified SPS parameter being based on modifying the SPS parameter.

In some aspects, method 800 further includes measuring the channel condition.

In some aspects, method 800 further includes modifying the SPS parameter, to obtain the modified SPS parameter, based on the trigger condition and the channel condition.

In some aspects, the SPS parameter indicates a range of resource blocks for transmission, wherein block 820 includes communicating on one or more resource blocks of the range of resource blocks.

In some aspects, the SPS parameter further indicates a number of selected resource blocks, wherein the one or more resource blocks include the number of selected resource blocks.

In some aspects, another resource block, of the range of resource blocks, is excluded from the one or more resource blocks based on an associated SNR value or an associated capacity value of the other resource block failing to satisfy a second threshold.

In some aspects, the trigger condition comprises a change in a SNR value or a capacity value of the channel condition satisfying a threshold.

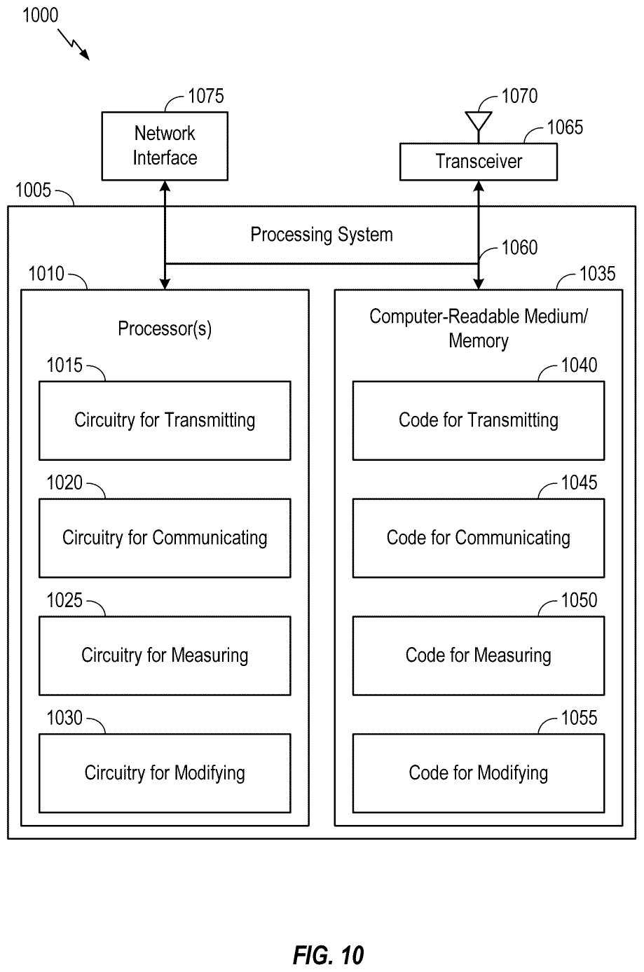

In some aspects, method 800, or any aspect related to it, may be performed by an apparatus, such as communications device 1000 of FIG. 10, which includes various components operable, configured, or adapted to perform the method 800. Communications device 1000 is described below in further detail.

Note that FIG. 8 is just one example of a method, and other methods including fewer, additional, or alternative operations are possible consistent with this disclosure.

### Example Communications Devices

FIG. 9 depicts aspects of an example communications device 900 configured for wireless communications. In some aspects, communications device 900 is a user equipment, such as UE 104 described above with respect to FIG. 1 or UE 304 described with respect to FIG. 3.

The communications device 900 includes a processing system 905 coupled to a transceiver 975 (e.g., a transmitter and/or a receiver). The transceiver 975 is configured to transmit and receive signals for the communications device 900 via an antenna 980, such as the various signals as described herein. The processing system 905 may be configured to perform processing functions for the communications device 900, including processing signals received and/or to be transmitted by the communications device 900.

The processing system 905 includes one or more processors 910 and a computer-readable medium/memory 940. In various aspects, the one or more processors 910 may be representative of the one or more processors 318 described with respect to FIG. 3. The one or more processors 910 are coupled to a computer-readable medium/memory 940 via a bus 970. In some aspects, the computer-readable medium/memory 940 may be representative of the one or more memories 320 described with respect to FIG. 3. The computer-readable medium/memory 940 is a non-transitory computer-readable medium/memory. In some aspects, the computer-readable medium/memory 940 is configured to store instructions (e.g., computer-executable code), that when executed by the one or more processors 910, cause the one or more processors 910 to perform the method 700 described with respect to FIG. 7, or any aspect related to it, including any operations described in relation to FIG. 7. Note that reference to a processor performing a function of communications device 900 may include one or more processors performing that function of communications device 900, such as in a distributed fashion.

In the depicted example, computer-readable medium/memory 940 stores code (e.g., executable instructions), including code for receiving 945, code for communicating 950, code for measuring 955, code for modifying 960, and code for determining 965. Processing of the code 945-965 may enable and cause the communications device 900 to perform the method 700 described with respect to FIG. 7, or any aspect related to it. For instance, in some aspects, code for receiving 945 includes code for receiving a SPS configuration that indicates a trigger condition for modifying an SPS parameter, wherein the SPS parameter is indicated by activation signaling for an SPS resource of the SPS configuration. In some aspects, code for receiving 945 includes code for receiving the activation signaling indicating the SPS parameter. In some aspects, code for communicating 950 includes code for communicating, based on a channel condition satisfying the trigger condition, using a modified SPS parameter, the modified SPS parameter being based on modifying the SPS parameter.

The one or more processors 910 include circuitry configured to implement (e.g., execute) the code stored in the computer-readable medium/memory 940, including circuitry for receiving 915, circuitry for communicating 920, circuitry for measuring 925, circuitry for modifying 930, and circuitry for determining 935. Processing with circuitry 915-935 may enable and cause the communications device 900 to perform the method 700 described with respect to FIG. 7, or any aspect related to it. For instance, in some aspects, circuitry for receiving 915 includes circuitry for receiving a SPS configuration that indicates a trigger condition for modifying an SPS parameter, wherein the SPS parameter is indicated by activation signaling for an SPS resource of the SPS configuration. In some aspects, circuitry for receiving 915 includes circuitry for receiving the activation signaling indicating the SPS parameter. In some aspects, circuitry for communicating 920 includes circuitry for communicating, based on a channel condition satisfying the trigger condition, using a modified SPS parameter, the modified SPS parameter being based on modifying the SPS parameter.

More generally, means for communicating, transmitting, sending or outputting for transmission may include the one or more transceivers 324, one or more antenna 322 and/or processing system 316 of the UE 304 illustrated in FIG. 3, transceiver 975 and/or antenna 980 of the communications device 900 in FIG. 9, and/or one or more processors 910 of the communications device 900 in FIG. 9. Means for communicating, receiving or obtaining may include the one or more transceivers 324, one or more antennas 322, and/or processing system 316 of the UE 304 illustrated in FIG. 3, transceiver 975 and/or antenna 980 of the communications device 900 in FIG. 9, and/or one or more processors 910 of the communications device 900 in FIG. 9.

FIG. 10 depicts aspects of an example communications device configured for wireless communications. In some aspects, communications device 1000 is a network entity, such as BS 102 of FIG. 1, first network entity 300 or second network entity 302 of FIG. 3, or a disaggregated base station as discussed with respect to FIG. 2.

The communications device 1000 includes a processing system 1005 coupled to a transceiver 1065 (e.g., a transmitter and/or a receiver) and/or a network interface 1075. The transceiver 1065 is configured to transmit and receive signals for the communications device 1000 via an antenna 1070, such as the various signals as described herein. The network interface 1075 is configured to obtain and send signals for the communications device 1000 via communications link(s), such as a backhaul link, midhaul link, and/or fronthaul link as described herein, such as with respect to FIG. 2. The processing system 1005 may be configured to perform processing functions for the communications device 1000, including processing signals received and/or to be transmitted by the communications device 1000.

The processing system 1005 includes one or more processors 1010 and a computer-readable medium/memory 1035. In various aspects, one or more processors 1010 may be representative of the one or more processors 308, as described with respect to FIG. 3. The one or more processors 1010 are coupled to the computer-readable medium/memory 1035 via a bus 1060. In some aspects, the computer-readable medium/memory 1035 is configured to store instructions (e.g., computer-executable code), including code 1040-1055, that when executed by the one or more processors 1010, cause the one or more processors 1010 to perform the method 800 described with respect to FIG. 8, or any aspect related to it, including any operations described in relation to FIG. 8. The computer-readable medium/memory 1035 is a non-transitory computer-readable medium/memory. Note that reference to a processor of communications device 1000 performing a function may include one or more processors of communications device 1000 performing that function, such as in a distributed fashion.

In the depicted example, the computer-readable medium/memory 1035 stores code (e.g., executable instructions), including code for transmitting 1040, code for communicating 1045, code for measuring 1050, and code for modifying 1055. Processing of the code 1040-1055 may enable and cause the communications device 1000 to perform the method 800 described with respect to FIG. 8, or any aspect related to it. For instance, in some aspects, code for transmitting 1040 includes code for transmitting a SPS configuration that indicates a trigger condition for modifying an SPS parameter, wherein the SPS parameter is indicated by activation signaling for an SPS resource of the SPS configuration. In some aspects, code for transmitting 1040 includes code for transmitting the activation signaling indicating the SPS parameter. In some aspects, code for communicating 1045 includes code for communicating, based on a channel condition satisfying the trigger condition, using a modified SPS parameter, the modified SPS parameter being based on modifying the SPS parameter.

The one or more processors 1010 include circuitry configured to implement (e.g., execute) the code stored in the computer-readable medium/memory 1035, including circuitry for transmitting 1015, circuitry for communicating 1020, circuitry for measuring 1025, and circuitry for modifying 1030. Processing with circuitry 1015-1030 may enable and cause the communications device 1000 to perform the method 800 described with respect to FIG. 8, or any aspect related to it. For instance, in some aspects, circuitry for transmitting 1015 includes circuitry for transmitting a SPS configuration that indicates a trigger condition for modifying an SPS parameter, wherein the SPS parameter is indicated by activation signaling for an SPS resource of the SPS configuration. In some aspects, circuitry for transmitting 1015 includes circuitry for transmitting the activation signaling indicating the SPS parameter. In some aspects, circuitry for communicating 1020 includes circuitry for communicating, based on a channel condition satisfying the trigger condition, using a modified SPS parameter, the modified SPS parameter being based on modifying the SPS parameter.

Various components of the communications device 1000 may provide means for performing the method 800 described with respect to FIG. 8, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1065, antenna 1070, and/or network interface 1075 of the communications device 1000 in FIG. 10, and/or one or more processors 1010 of the communications device 1000 in FIG. 10. Means for communicating, receiving or obtaining may include the one or more transceivers 312, one or more antennas 314, and/or processing system 306 of the first network entity 300 or the second network entity 302 illustrated in FIG. 3, transceiver 1065, antenna 1070, and/or network interface 1075 of the communications device 1000 in FIG. 10, and/or one or more processors 1010 of the communications device 1000 in FIG. 10.

### Example Clauses

Implementation examples are described in the following numbered clauses:
Clause 1: A method for wireless communications by a UE comprising: receiving a SPS configuration that indicates a trigger condition for modifying an SPS parameter, wherein the SPS parameter is indicated by activation signaling for an SPS resource of the SPS configuration; receiving the activation signaling indicating the SPS parameter; and communicating, based on a channel condition satisfying the trigger condition, using a modified SPS parameter, the modified SPS parameter being based on modifying the SPS parameter.
Clause 2: The method of Clause 1, further comprising: measuring the channel condition; and modifying the SPS parameter, to obtain the modified SPS parameter, based on the trigger condition and the channel condition.
Clause 3: The method of Clause 2, further comprising modifying the SPS parameter without receiving signaling indicating to modify the SPS parameter.
Clause 4: The method of Clause 2, wherein modifying the SPS parameter comprises modifying the SPS parameter, based on the channel condition, using a machine learning model.
Clause 5: The method of Clause 2, wherein the SPS parameter indicates a range of resource blocks for transmission, wherein communicating using the modified SPS parameter comprises communicating on one or more resource blocks of the range of resource blocks.
Clause 6: The method of Clause 5, wherein the channel condition is based on a SNR or a capacity, and wherein the one or more resource blocks are based on one or more SNR values or one or more capacity values of the one or more resource blocks.
Clause 7: The method of Clause 5, wherein the SPS parameter further indicates a number of selected resource blocks, wherein the one or more resource blocks include the number of selected resource blocks.
Clause 8: The method of Clause 7, wherein another resource block, of the range of resource blocks, is excluded from the one or more resource blocks based on an associated SNR value or an associated capacity value of the other resource block failing to satisfy a second threshold.
Clause 9: The method of any one of Clauses 1-8, further comprising: determining that the trigger condition is no longer satisfied; and communicating using a default SPS parameter in accordance with the trigger condition not being satisfied.
Clause 10: The method of any one of Clauses 1-9, wherein the trigger condition comprises a change in a SNR value or a capacity value of the channel condition satisfying a threshold.
Clause 11: The method of any one of Clauses 1-10, wherein the channel condition is based on a past measurement according to a time delay.
Clause 12: The method of any one of Clauses 1-11, wherein the SPS parameter includes a first modulation and coding scheme and the modified SPS parameter includes a second modulation and coding scheme.
Clause 13: The method of any one of Clauses 1-12, wherein the SPS parameter includes a first rank and the modified SPS parameter includes a second rank.
Clause 14: A method for wireless communications by a network entity comprising: transmitting a SPS configuration that indicates a trigger condition for modifying an SPS parameter, wherein the SPS parameter is indicated by activation signaling for an SPS resource of the SPS configuration; transmitting the activation signaling indicating the SPS parameter; and communicating, based on a channel condition satisfying the trigger condition, using a modified SPS parameter, the modified SPS parameter being based on modifying the SPS parameter.
Clause 15: The method of Clause 14, further comprising: measuring the channel condition; and modifying the SPS parameter, to obtain the modified SPS parameter, based on the trigger condition and the channel condition.
Clause 16: The method of Clause 15, wherein the SPS parameter indicates a range of resource blocks for transmission, wherein communicating using the modified SPS parameter comprises communicating on one or more resource blocks of the range of resource blocks.
Clause 17: The method of Clause 16, wherein the SPS parameter further indicates a number of selected resource blocks, wherein the one or more resource blocks include the number of selected resource blocks.
Clause 18: The method of Clause 17, wherein another resource block, of the range of resource blocks, is excluded from the one or more resource blocks based on an associated SNR value or an associated capacity value of the other resource block failing to satisfy a second threshold.
Clause 19: The method of any one of Clauses 14-18, wherein the trigger condition comprises a change in a SNR value or a capacity value of the channel condition satisfying a threshold.
Clause 20: One or more apparatuses, comprising: one or more memories; and one or more processors configured to cause the one or more apparatuses to perform a method in accordance with any one of Clauses 1-19.
Clause 21: One or more apparatuses configured for wireless communications, comprising: one or more memories; and one or more processors, coupled to the one or more memories, configured to cause the one or more apparatuses to perform a method in accordance with any one of Clauses 1-19.
Clause 22: One or more apparatuses configured for wireless communications, comprising: one or more memories; and one or more processors, coupled to the one or more memories, configured to perform a method in accordance with any one of Clauses 1-19.
Clause 23: One or more apparatuses, comprising means for performing a method in accordance with any one of Clauses 1-19.
Clause 24: One or more non-transitory computer-readable media comprising executable instructions that, when executed by one or more processors of one or more apparatuses, cause the one or more apparatuses to perform a method in accordance with any one of Clauses 1-19.
Clause 25: One or more computer program products embodied on one or more computer-readable storage media comprising code for performing a method in accordance with any one of Clauses 1-19.
Clause 26: One or more apparatuses configured for wireless communications, comprising: a processing system that includes one or more processors and one or more memories coupled with the one or more processors, the processing system configured to cause the one or more apparatuses to perform a method in accordance with any one of Clauses 1-19.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
receive a semi-persistent scheduling (SPS) configuration that indicates a trigger condition for modifying an SPS parameter, wherein the SPS parameter is indicated by activation signaling for an SPS resource of the SPS configuration;
receive the activation signaling indicating the SPS parameter; and
communicate, based on a channel condition satisfying the trigger condition, using a modified SPS parameter, the modified SPS parameter being based on modifying the SPS parameter.

2. The apparatus of claim 1, wherein the processing system is configured to cause the UE to:
measure the channel condition; and
modify the SPS parameter, to obtain the modified SPS parameter, based on the trigger condition and the channel condition.

3. The apparatus of claim 2, wherein the processing system is configured to cause the UE to modify the SPS parameter without receiving signaling indicating to modify the SPS parameter.

4. The apparatus of claim 2, wherein to cause the UE to modify the SPS parameter, the processing system is configured to cause the UE to modify the SPS parameter, based on the channel condition, using a machine learning model.

5. The apparatus of claim 2, wherein the SPS parameter indicates a range of resource blocks for transmission, wherein to cause the UE to communicate using the modified SPS parameter, the processing system is configured to cause the UE to communicate on one or more resource blocks of the range of resource blocks.

6. The apparatus of claim 5, wherein the channel condition is based on a signal-to-noise ratio (SNR) or a capacity, and wherein the one or more resource blocks are based on one or more SNR values or one or more capacity values of the one or more resource blocks.

7. The apparatus of claim 5, wherein the SPS parameter further indicates a number of selected resource blocks, wherein the one or more resource blocks include the number of selected resource blocks.

8. The apparatus of claim 7, wherein another resource block, of the range of resource blocks, is excluded from the one or more resource blocks based on an associated signal-to-noise ratio (SNR) value or an associated capacity value of the other resource block failing to satisfy a second threshold.

9. The apparatus of claim 1, wherein the processing system is configured to cause the UE to determine that the trigger condition is no longer satisfied, and wherein the processing system is configured to cause the UE to communicate using a default SPS parameter in accordance with the trigger condition not being satisfied.

10. The apparatus of claim 1, wherein the trigger condition comprises a change in a signal-to-noise ratio (SNR) value or a capacity value of the channel condition satisfying a threshold.

11. The apparatus of claim 1, wherein the channel condition is based on a past measurement according to a time delay.

12. The apparatus of claim 1, wherein the SPS parameter includes a first modulation and coding scheme and the modified SPS parameter includes a second modulation and coding scheme.

13. The apparatus of claim 1, wherein the SPS parameter includes a first rank and the modified SPS parameter includes a second rank.

14. An apparatus for wireless communications, comprising a processing system that includes one or more processors and one or more memories coupled with the one or more processors, the processing system configured to cause a network entity to:
transmit a semi-persistent scheduling (SPS) configuration that indicates a trigger condition for modifying an SPS parameter, wherein the SPS parameter is indicated by activation signaling for an SPS resource of the SPS configuration;
transmit the activation signaling indicating the SPS parameter; and
communicate, based on a channel condition satisfying the trigger condition, using a modified SPS parameter, the modified SPS parameter being based on modifying the SPS parameter.

15. The apparatus of claim 14, wherein the processing system is configured to cause the network entity to:
measure the channel condition; and
modify the SPS parameter, to obtain the modified SPS parameter, based on the trigger condition and the channel condition.

16. The apparatus of claim 15, wherein the SPS parameter indicates a range of resource blocks for transmission, wherein to cause the network entity to communicate using the modified SPS parameter, the processing system is configured to cause the network entity to communicate on one or more resource blocks of the range of resource blocks.

17. The apparatus of claim 16, wherein the SPS parameter further indicates a number of selected resource blocks, wherein the one or more resource blocks include the number of selected resource blocks.

18. The apparatus of claim 17, wherein another resource block, of the range of resource blocks, is excluded from the one or more resource blocks based on an associated SNR value or an associated capacity value of the other resource block failing to satisfy a second threshold.

19. The apparatus of claim 14, wherein the trigger condition comprises a change in a signal-to-noise ratio (SNR) value or a capacity value of the channel condition satisfying a threshold.

20. A method of wireless communications, comprising:
transmitting a semi-persistent scheduling (SPS) configuration that indicates a trigger condition for modifying an SPS parameter, wherein the SPS parameter is indicated by activation signaling for an SPS resource of the SPS configuration;
transmitting the activation signaling indicating the SPS parameter; and
communicating, based on a channel condition satisfying the trigger condition, using a modified SPS parameter, the modified SPS parameter being based on modifying the SPS parameter.
